(19) United States
(12) Patent Application Publication
(10) Pub. No.: US 2018/0238747 A1
(43) Pub. Date: Aug. 23, 2018

(54) APPARATUS AND METHOD FOR MEASURING WATER TEMPERATURE IN PIPE

(71) Applicant: Samsung Electro-Mechanics Co., Ltd., Suwon-si (KR)

(72) Inventors: Byong Hyok CHOI, Suwon-si (KR); Seung Hun PAEK, Suwon-si (KR); Ui Soo LEE, Suwon-si (KR)

(73) Assignee: Samsung Electro-Mechanics Co., Ltd., Suwon-si (KR)

(21) Appl. No.: 15/826,465

(22) Filed: Nov. 29, 2017

(30) Foreign Application Priority Data
Feb. 21, 2017 (KR) 10-2017-0023184

(51) Int. Cl. G01K 13/02

(52) U.S. Cl. CPC G01K 13/02; G01K 2013/026

(57) ABSTRACT

An apparatus for measuring a water temperature in a pipe in which water is carried includes: a temperature measuring sensor configured to be installed on an external surface of the pipe to measure an external surface temperature of the pipe; and a water temperature detector configured to receive the external surface temperature from the temperature measuring sensor, and to determine whether there is water-flow in the pipe based on the external surface temperature at a first measurement time and the external surface temperature at a second measurement time.

### CROSS-REFERENCE TO RELATED APPLICATIONS

This application claims the benefit under 35 USC 119(a) of Korean Patent Application No. 10-2017-0023184 filed on Feb. 21, 2017 in the Korean Intellectual Property Office, the entire disclosure of which is incorporated herein by reference for all purposes.

### BACKGROUND

### 1. Field

The following description relates to an apparatus and method for measuring a water temperature in a pipe which may be applied to a low power wide area (LPWA) network.

### 2. Description of Related Art

A low power wide area (LPWA) module coupled to various sensors has recently been used in smart metering applications. In addition, such an LPWA module may also be utilized to measure and transmit a water temperature in order to monitor water supplies having a constant water temperature. In this case, a technology of accurately measuring a temperature of water supplied through a pipe is required.

Further, in order to accurately measure the temperature of the water supplied through the pipe, the temperature of the water should be measured while the water in the pipe is flowing. To this end, a water-flow first needs to be detected. In this case, water-flow detection outside the pipe is sometimes required without drilling or cutting the pipe.

However, according to related art, a method for detecting a water-flow includes installing a sensor in the pipe by drilling or cutting the pipe. However, such a method has a disadvantage of damaging the pipe.

In addition, a method for performing the water-flow detection outside the pipe without damaging the pipe according to related art employs an ultrasound sensor, but such a method is disadvantageous in that the cost of an apparatus is too expensive and the size of the apparatus is also too large.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus to measure a water temperature in a pipe in which water is carried includes: a temperature measuring sensor configured to be installed on an external surface of the pipe to measure an external surface temperature of the pipe; and a water temperature detector configured to receive the external surface temperature from the temperature measuring sensor, and to determine whether there is water-flow in the pipe based on the external surface temperature at a first measurement time and the external surface temperature at a second measurement time.

The water temperature detector may be further configured to compare a measured temperature change between the first and second measurement times based on the external surface temperature with a reference temperature change, and to determine that there is water-flow in the pipe when the measured temperature change exceeds the reference temperature change.

The water temperature detector may be further configured to variably determine the reference temperature change based on a level of the external surface temperature at the first measurement time.

The water temperature detector may be further configured to determine that there is water-flow in the pipe when a measured temperature change exceeds a reference temperature change, and to calculate an internal water temperature of the pipe based on the external surface temperature and a pipe parameter of the pipe.

The water temperature detector may include a memory configured to store a parameter including a standard and physical characteristic value of the pipe, the external surface temperature at measurement times including the first and second measurement times, whether there is water-flow in the pipe, a corresponding time at which it is determined whether there is water-flow in the pipe, and an internal water temperature of the pipe, and a controller configured to compare a measured temperature change between the first and second measurement times with a reference temperature change, to determine whether there is water-flow in the pipe, to determine that there is water-flow in the pipe in response to the measured temperature change exceeding the reference temperature change, and to calculate the internal water temperature of the pipe based on the parameter.

The water temperature detector may be further configured to calculate the internal water temperature of the pipe based on the external surface temperature and the pipe parameter of the pipe using

$$TS = TI ( 1 - {e}^{- \frac{t}{τ}} ) , τ = \frac{{h}^{2}}{{π}^{2} * D} , D = \frac{k}{ρ * Cp} ,$$

wherein TS is the external surface temperature, TI is the internal water temperature of the pipe, t is a measurement time interval, τ is a thermal time constant of a pipe material, h is a thickness (mm) of the pipe, D is material diffusivity ( ) of the pipe, k is thermal conductivity (W/m*K), ρ is material density ( ) of the pipe, and Cp is material specific heat capacity of the pipe (J/kg*K).

In another general aspect, a method to measure a water temperature in a pipe in which water is carried includes: measuring an external surface temperature of the pipe, using a temperature measuring sensor disposed on an external surface of the pipe; and determining, by a water temperature detector that receives the external surface temperature from the temperature measuring sensor at measurement times, whether there is water-flow in the pipe based on the external surface temperature at a first measurement time among the measurement times, and the external surface temperature at a second measurement time among the measurement times.

The method may further include calculating an internal water temperature of the pipe based on the external surface temperature and a pipe parameter of the pipe, in response to the determining of whether there is water-flow in the pipe resulting in a determination that there is water-flow in the pipe.

The determining of whether there is water-flow in the pipe may include comparing a measured temperature change between the first and second measurement times based on the external surface temperature with a reference temperature change, and determining that there is water-flow in the pipe in response to the measured temperate change exceeding the reference temperature change.

The determining of whether there is water-flow in the pipe may include variably determining the reference temperature change based on a level of the first measured temperature.

The calculating of the internal water temperature of the pipe may include calculating the internal water temperature of the pipe based on the external surface temperature and the pipe parameter of the pipe using

$$TS = TI ( 1 - {e}^{- \frac{t}{τ}} ) , τ = \frac{{h}^{2}}{{π}^{2} * D} , D = \frac{k}{ρ * Cp} ,$$

wherein TS is the external surface temperature, TI is the internal water temperature of the pipe, t is a measurement time interval, τ is a thermal time constant of a pipe material, h is a thickness (mm) of the pipe, D is material diffusivity ( ) of the pipe, k is thermal conductivity (W/m*K), ρ is material density ( ) of the pipe, and Cp is material specific heat capacity of the pipe (J/kg*K).

The temperature measuring sensor may be installed on the external surface of the pipe without cutting or drilling the pipe.

A non-transitory, computer-readable storage medium may store instructions that, when executed by a processor, cause the processor to perform the method.

Other features and aspects will be apparent from the following detailed description, the drawings, and the claims.

### BRIEF DESCRIPTION OF DRAWINGS

FIG. 1 is a schematic view of an apparatus for measuring a water temperature in a pipe, according to an embodiment.

FIG. 2 is another schematic view of an apparatus for measuring a water temperature in a pipe, according to an embodiment.

FIG. 3 is a graph illustrating a hot water temperature change in a pipe, according to an embodiment.

FIG. 4 is a graph illustrating a cold water temperature change in a pipe, according to an embodiment.

FIG. 5 is a table illustrating an example of a standard size for each of pipe types, according an embodiment.

FIG. 6 is a graph illustrating a change in an external surface temperature of a pipe, according to an embodiment.

FIG. 7 is a flow chart illustrating a method for measuring a water temperature in a pipe, according to an embodiment.

FIG. 8 is another flow chart illustrating a method for measuring a water temperature in a pipe, according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” “coupled to,” “over,” or “covering” another element, it may be directly “on,” “connected to,” “coupled to,” “over,” or “covering” the other element, or there may be one or more other elements intervening therebetween. In contrast, when an element is described as being “directly on,” “directly connected to,” “directly coupled to,” “directly over,” or “directly covering” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

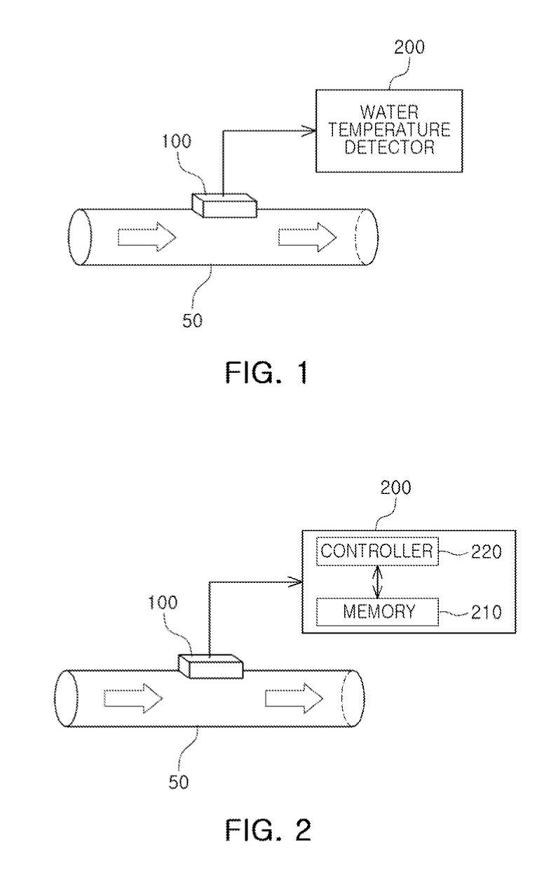

FIG. 1 is a schematic view of an apparatus for measuring a water temperature in a pipe, according to an embodiment.

Referring to FIG. 1, the apparatus for measuring a water temperature in a pipe includes a temperature measuring sensor 100 and a water temperature detector 200.

The temperature measuring sensor 100 is installed on an external surface of a pipe 50 in which water is carried to measure an external surface temperature TS of the pipe 50.

As an example, the pipe 50 is formed of a material having high thermal conductivity such as copper. An embodiment in which the pipe 50 is a copper pipe will be described herein, but the pipe 50 is not limited to being a copper pipe.

As an example, at least one thermistor is used as the temperature measuring sensor 100. In this example, the thermistor measures the external surface temperature of the pipe once every predetermined or specified measurement time (e.g., within 10 seconds) and transmits the measured external surface temperature to the water temperature detector 200. That is, the thermistor measures the external surface temperature at specified time intervals.

As an example, the temperature measuring sensor 100 includes two or more thermistors which are disposed in different positions in the pipe 50. In this case, one of the two or more thermistors is selectively used based on a measured temperature state, and all of the thermistors may be used for more accurate measurement.

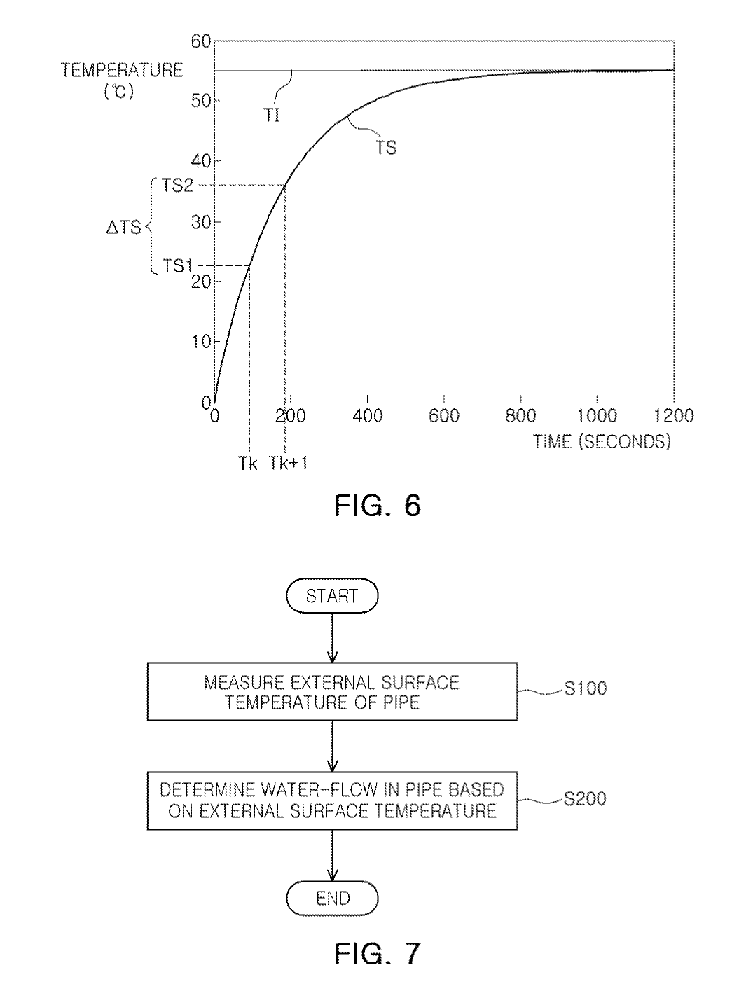

The water temperature detector 200 receives the external surface temperature from the temperature measuring sensor 100 every measurement time, and determines whether there is water-flow in the pipe 50 based on the external surface temperatures TS1 and TS2 (see FIG. 6) at two points in time.

The water temperature detector 200 compares a measured temperature change (ΔTS=TS1-TS2, see FIG. 6) between a first measurement time Tk and a second measurement time Tk+1 with a reference temperature change Tref. TS1 and TS2 are external surface temperatures of the pipe 50 at measurement times Tk and Tk+1, respectively. The water temperature detector 200 determines that there is water-flow in the pipe 50 when the measured temperate change (ΔTS) exceeds the reference temperature change Tref.

As an example, the water temperature detector 200 determines that there is water-flow when the measured temperature change between the external surface temperatures of the two points of time has a difference of the reference temperature change (e.g., 3° C.) or more.

As an example, the water temperature detector 200 determines that there is water-flow in the pipe 50 when the measured temperature change ΔTS exceeds the reference temperature change Tref and calculates an internal water temperature TI of the pipe 50 based on the external surface temperature TS and a pipe parameter of the pipe 50.

In the respective drawings of the present disclosure, unnecessary overlapped descriptions are possibly omitted for components having the same reference numeral and the same function, and differences will be described.

FIG. 2 is another schematic view of the apparatus for measuring a water temperature in a pipe, according to an embodiment.

Referring to FIG. 2, the water temperature detector 200 includes a memory 210 and a controller 220. The memory 210 stores a pipe parameter including a standard and physical characteristic value of the pipe 50, the external surface temperature TS received every measurement time including the first and second measurement times Tk and Tk+1 (see FIG. 6), whether there is water-flow in the pipe, a corresponding time at which it is determined whether there is water flow, and an internal temperature.

The controller 220 compares the measured temperature change ΔTS between the first and second measurement times Tk and Tk+1 and the reference temperature change with each other and determine whether there is water-flow in the pipe 50.

Further, the controller 220 determines that there is water-flow in the pipe 50 when the measured temperature change ΔTS exceeds the reference temperature change Tref and calculates an internal water temperature TI of the pipe 50 based on the external surface temperature TS and a pipe parameter of the pipe 50.

Referring to FIGS. 1 and 2, the water temperature detector 200 variably determines the reference temperature change Tref based on a level of a first measured temperature TS1 of the first measurement time Tk.

For example, since the first measured temperature TS1 may be different according to the first measurement time Tk and a water temperature change gradient in the pipe is changed (see FIG. 6) when the first measured temperature TS1 is different, the reference temperature change is set differently according to the first measured temperature TS1.

As an example, the water temperature detector 200 calculates the internal water temperature TI of the pipe 50 based on the external surface temperature TS and the pipe parameter of the pipe 50 using Equation 1 below.

$$TS = TI ( 1 - {e}^{- \frac{t}{τ}} ) , τ = \frac{{h}^{2}}{{π}^{2} * D} , D = \frac{k}{ρ * Cp} \qquad [ Equation 1 ]$$

In Equation 1, TS is an external surface temperature, TI is an internal water temperature of the pipe 50, t is a measurement time interval Tk+1−Tk, τ is a thermal time constant of a pipe material, h is a thickness (mm) of the pipe, D is material diffusivity (m²/s*10⁻⁶) of the pipe, k is thermal conductivity (W/m*K), ρ is material density (kg/m³) of the pipe, and Cp is material specific heat capacity of the pipe (J/kg*K).

According to an embodiment, in a case in which the pipe 50 is a copper pipe, when water having a predetermined temperature flows in the copper pipe, an example of a pipe parameter of the copper pipe for calculating the external surface temperature TS of the copper pipe is as illustrated in Table 1 below.

TABLE 1

| Parameter | Value | |
|---|---|---|
| h: thickness of pipe | 1 | mm |
| k: thermal conductivity | 398 | W/m*K |
| ρ: density | 8960 | kg/m³ |
| Cp: specific heat capacity | 386 | J/kg*K |

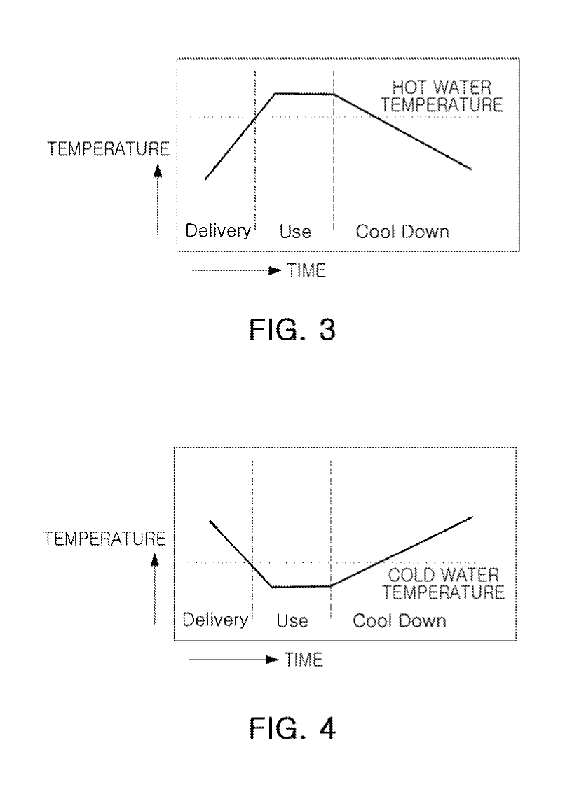

FIG. 3 is a graph illustrating a hot water temperature change in a pipe, according to an embodiment. FIG. 4 is a graph illustrating a cold water temperature change in a pipe, according to an embodiment.

In FIGS. 3 and 4, according to an embodiment, in a case in which the internal temperature of the pipe maintains a predetermined or specified level (e.g., 10 to 60° C.), when the water-flow occurs in a hot water pipe and a cold water pipe, respectively, a hot water temperature change in the pipe and a cold water temperature change in the pipe are as illustrated in FIGS. 3 and 4, respectively.

As illustrated in FIG. 3, in the case of a hot water pipe, it is determined that the water-flow occurs when a temperature increase within a predetermined or specified time exceeds a predetermined level.

As illustrated in FIG. 4, in the case of a cold water pipe, it is determined that the water-flow occurs when a temperature decrease within a predetermined or specified time exceeds a predetermined level.

The predetermined time and the level of the temperature change (e.g., the increase or the decrease) is obtained by observing a change of an external surface temperature for the internal temperature of the pipe as illustrated in FIG. 6, through a thermal time constant of a material forming the pipe and a thickness of the pipe, where the temperature of the supplied hot water or cold water may be an important variable.

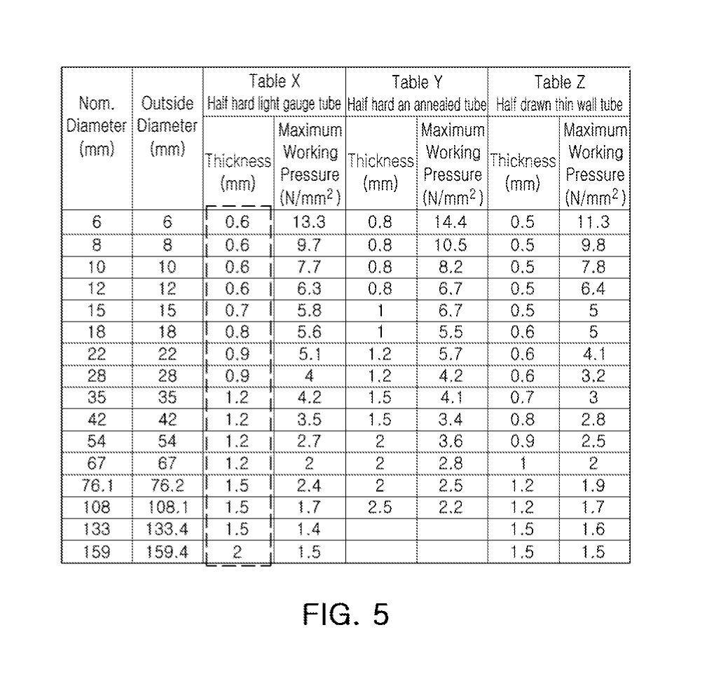

FIG. 5 is a table illustrating an example of a standard size for each of pipe types, according an embodiment.

The table illustrated in FIG. 5 illustrates a Table X, a Table Y, and a Table Z in which a thickness (mm) and a maximum working pressure are provided according to an outside diameter for a type X, a type Y, and a type Z of the pipe which are typically used.

In the table illustrated in FIG. 5, a thickness of a copper pipe of the type X has a value between 0.6 and 2 mm. As an example, a circumference of the copper pipe used as a water pipe in a toilet is 22 to 35 mm, and a thickness corresponding to the above-mentioned circumference is about 1 mm. Therefore, according to an embodiment, it can be assumed that the thickness of the copper pipe is 1 mm.

FIG. 6 is a graph illustrating a change in an external surface temperature of a pipe, according to an embodiment.

When water of a temperature of 55° C. flows in the copper pipe, a change in an external surface temperature of the copper pipe may be represented as illustrated in FIG. 6 by using the pipe parameter of the copper pipe, according to an embodiment.

Referring to the graph illustrated in FIG. 6, it can be seen that the external surface temperature TS of the pipe is gradually increased over time and becomes equal to the internal water temperature TI.

As an example, in a case in which water of 55° C. is supplied, when the water continues to flow, a temperature of water (water temperature) will continue to remain at 55° C., but when the water repeatedly flows and stops, the temperature of the water will not remain accurately at 55° C., but will remain within a certain water temperature range.

Accordingly, assuming that the external surface temperature TS of the pipe is currently 30° C. or more, when there is water-flow, the external surface temperature of the pipe is rapidly increased in a short time, as illustrated in FIG. 6 (e.g., an increase of about 5° C. or more in 50 seconds).

As a result, when the temperature change of a predetermined or specified level or more occurs within a predetermined or specified time, it may be determined that there is water-flow.

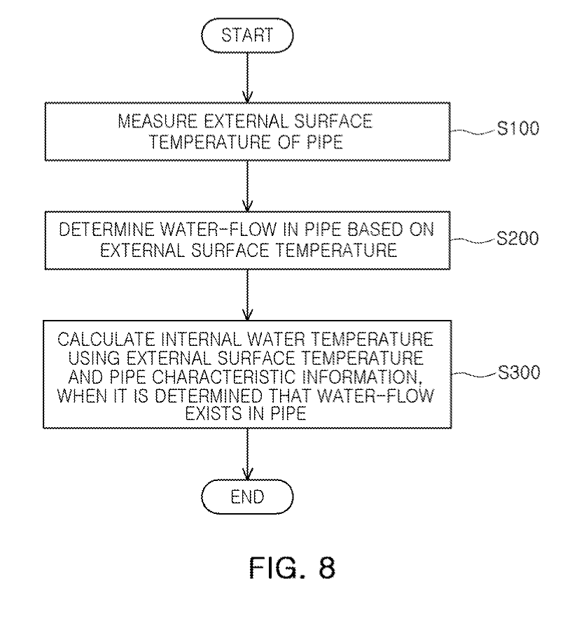

Hereinafter, a method for measuring a water temperature in a pipe will be described with reference to FIGS. 7 and 8. In this disclosure, the description for the apparatus for measuring the water temperature in the pipe and the description for the method for measuring the water temperature in the pipe may be supplemented with each other, unless otherwise specified. As an example, the description made with reference to FIGS. 1 through 6 may be applied to the method for measuring the water temperature described herein, and accordingly, an overlapping detailed description may be omitted in the description for the method for measuring the water temperature in the pipe.

FIG. 7 is a flow chart illustrating a method for measuring a water temperature in a pipe, according to an embodiment. FIG. 8 is another flow chart illustrating a method for measuring a water temperature in a pipe, according to an embodiment.

Referring to FIGS. 7 and 8, first, in operation S100, the temperature measuring sensor 100 installed on the external surface of the pipe 50 in which water is carried measures the external surface temperature TS of the pipe 50. The measured external surface temperature is transmitted to the water temperature detector 200.

Next, in operation S200, the water temperature detector 200 determines whether there is water-flow in the pipe 50 based on the external surface temperatures TS1 and TS2, which are received at different measurement times from the temperature measuring sensor 100.

In addition, referring to FIG. 8, in response to it being determined in the operation S200 that there is water-flow in the pipe 50, the method for measuring the water temperature in the pipe may further include an operation S300 in which the water temperature detector 200 calculates an internal water temperature TI of the pipe 50 based on the external surface temperature TS and the pipe parameter of the pipe 50.

Referring to FIGS. 7 and 8, in the operation S200, the water temperature detector 200 compares a measured temperature change (ΔTS=TS1−TS2) between a first measurement time Tk and a second measurement time Tk+1 with a reference temperature change Tref. TS1 and TS2 are external surface temperatures of the pipe 50 at measurement times Tk and Tk+1, respectively. The water temperature detector 200 determines that there is water-flow in the pipe 50 when the measured temperate change (ΔTS) exceeds the reference temperature change Tref.

Further, in the operation S200, the water temperature detector 200 variably determines the reference temperature change Tref based on a level of a first measured temperature TS1 of the first measurement time Tk.

Further, in the operation S300, the water temperature detector 200 calculates the internal water temperature TI of the pipe 50 based on the external surface temperature TS and the pipe parameter of the pipe 50 using Equation 1 above.

According to the embodiments described above, as an example, the memory 210 stores an external measured temperature at intervals of 10 seconds for a predetermined or specified time (e.g., 10 minutes), or stores the external measured temperature at intervals of a predetermined or specified time (e.g., 10 minutes) for a predetermined or specified period of time (e.g., one month)t. Information on a corresponding time at which it is determined that there is water-flow, the internal temperature, and whether there is water-flow may be stored for a longer period of time (e.g., 6 months).

As an example, when turned on, the controller 200 calculates a temperature change table for each measurement time so that the reference temperature change Tref for each of the measurement times can be found when there is water-flow in the pipe by using the pipe parameter stored in the memory 210 (see FIG. 6).

As an example, it is determined whether the water-flow exists when a certain temperature change (e.g., 3° C.) within a predetermined or specified length of time (e.g., 30 seconds) occurs by using the temperature change table for each measurement time (a temperature change value for determining a fluid flow). Thereafter, the controller 220 receives the external surface temperature TS measured every 10 seconds from the temperature measuring sensor 100 and stores the received external surface temperature in the memory 210. At the same time, the controller 220 compares the changes of the external surface temperature within a recently predetermined or specified length of time (e.g., 30 seconds) every 10 seconds to check whether the measured temperature changes have a difference of a predetermined value (e.g., 3° C.) or more. If the measured temperature changes within the predetermined or specified length of time have the difference of the predetermined or specified value or more, the controller 220 determines that there is water-flow in the pipe, and stores a current time, an internal temperature, and whether a fluid-flow exists in the memory. Such operations are continued while it is determined that there is water-flow at an interval of every 10 seconds.

As set forth above, according to the embodiments disclosed herein, the water-flow is determined by using a measured temperature change based on external surface temperatures which are measured outside the pipe without damaging the pipe by, for example, drilling or cutting the pipe, whereby installation convenience is improved and installation costs are reduced as compared to conventional methods which damage the pipe.

Further, the water temperature in the pipe is more precisely measured based on the external surface temperature of the pipe by using the pipe parameters such as the physical parameter of the material of the pipe.

The water temperature detector 200, the memory 210, and the controller 220 in FIGS. 1 and 2 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 7 and 8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus to measure a water temperature in a pipe in which water is carried, the apparatus comprising:
a temperature measuring sensor configured to be installed on an external surface of the pipe to measure an external surface temperature of the pipe; and
a water temperature detector configured to receive the external surface temperature from the temperature measuring sensor, and to determine whether there is water-flow in the pipe based on the external surface temperature at a first measurement time and the external surface temperature at a second measurement time.

2. The apparatus of claim 1, wherein the water temperature detector is further configured to compare a measured temperature change between the first and second measurement times based on the external surface temperature with a reference temperature change, and to determine that there is water-flow in the pipe when the measured temperature change exceeds the reference temperature change.

3. The apparatus of claim 2, wherein the water temperature detector is further configured to variably determine the reference temperature change based on a level of the external surface temperature at the first measurement time.

4. The apparatus of claim 1, wherein the water temperature detector is further configured to determine that there is water-flow in the pipe when a measured temperature change exceeds a reference temperature change, and to calculate an internal water temperature of the pipe based on the external surface temperature and a pipe parameter of the pipe.

5. The apparatus of claim 1, wherein the water temperature detector comprises
a memory configured to store a parameter comprising a standard and physical characteristic value of the pipe, the external surface temperature at measurement times comprising the first and second measurement times, whether there is water-flow in the pipe, a corresponding time at which it is determined whether there is water-flow in the pipe, and an internal water temperature of the pipe, and
a controller configured to compare a measured temperature change between the first and second measurement times with a reference temperature change, to determine whether there is water-flow in the pipe, to determine that there is water-flow in the pipe in response to the measured temperature change exceeding the reference temperature change, and to calculate the internal water temperature of the pipe based on the parameter.

6. The apparatus of claim 5, wherein the water temperature detector is further configured to calculate the internal water temperature of the pipe based on the external surface temperature and the pipe parameter of the pipe using
$$TS = TI ( 1 - {e}^{- \frac{t}{τ}} ) , τ = \frac{{h}^{2}}{{π}^{2} * D} , D = \frac{k}{ρ * Cp} ,$$
wherein TS is the external surface temperature, TI is the internal water temperature of the pipe, t is a measurement time interval, τ is a thermal time constant of a pipe material, h is a thickness (mm) of the pipe, D is material diffusivity (m²/s*10⁻⁶) of the pipe, k is thermal conductivity (W/m*K), ρ is material density (kg/m³) of the pipe, and Cp is material specific heat capacity of the pipe (J/kg*K).

7. A method to measure a water temperature in a pipe in which water is carried, the method comprising:
measuring an external surface temperature of the pipe, using a temperature measuring sensor disposed on an external surface of the pipe; and
determining, by a water temperature detector that receives the external surface temperature from the temperature measuring sensor at measurement times, whether there is water-flow in the pipe based on the external surface temperature at a first measurement time among the measurement times, and the external surface temperature at a second measurement time among the measurement times.

8. The method of claim 7, further comprising calculating an internal water temperature of the pipe based on the external surface temperature and a pipe parameter of the pipe, in response to the determining of whether there is water-flow in the pipe resulting in a determination that there is water-flow in the pipe.

9. The method of claim 7, wherein the determining of whether there is water-flow in the pipe comprises
comparing a measured temperature change between the first and second measurement times based on the external surface temperature with a reference temperature change, and
determining that there is water-flow in the pipe in response to the measured temperate change exceeding the reference temperature change.

10. The method of claim 9, wherein the determining of whether there is water-flow in the pipe comprises variably determining the reference temperature change based on a level of the first measured temperature.

11. The method of claim 8, wherein in the calculating of the internal water temperature of the pipe comprises calculating the internal water temperature of the pipe based on the external surface temperature and the pipe parameter of the pipe using
$$TS = TI ( 1 - {e}^{- \frac{t}{τ}} ) , τ = \frac{{h}^{2}}{{π}^{2} * D} , D = \frac{k}{ρ * Cp} ,$$
wherein TS is the external surface temperature, TI is the internal water temperature of the pipe, t is a measurement time interval, τ is a thermal time constant of a pipe material, h is a thickness (mm) of the pipe, D is material diffusivity (m²/s*10⁻⁶) of the pipe, k is thermal conductivity (W/m*K), ρ is material density (kg/m³) of the pipe, and Cp is material specific heat capacity of the pipe (J/kg*K).

12. The method of claim 7, wherein the temperature measuring sensor is installed on the external surface of the pipe without cutting or drilling the pipe.

13. A non-transitory, computer-readable storage medium storing instructions that, when executed by a processor, cause the processor to perform the method of claim 7.
